(19) United States
(12) Patent Application Publication
(10) Pub. No.: US 2014/0215892 A1
(43) Pub. Date: Aug. 7, 2014

(54) Hook Setting Trigger

(71) Applicant: Anthony Joseph BARBER, Plymouth, WI (US)

(72) Inventor: Anthony Joseph BARBER, Plymouth, WI (US)

(21) Appl. No.: 14/174,509

(22) Filed: Feb. 6, 2014

Related U.S. Application Data
(60) Provisional application No. 61/762,048, filed on Feb. 7, 2013.

(51) Int. Cl. A01K 91/10

(52) U.S. Cl. CPC A01K 91/10
USPC 43/15

(57) ABSTRACT

A hook setting trigger is a device that automatically sets a fishing hook. The hook setting trigger utilizes a fisherman's existing or preferred fishing rod set up. The hook setting trigger is additionally able to adjust the sensitivity of the trigger. The hook setting trigger accomplishes this through the use of an elongated body, a line catch, a tension adjuster, an eyelet mount. The device functions complimentarily with a stabilizing base to retain a fishing rod and an anchored tether. The fishing rod is flexed and the hook setting trigger is mounted to the eyelet of the fishing rod. The baited fishing line is operatively coupled to the trigger and then positioned in the water. Upon receiving a tug on the fishing line from a biting fish, the hook setting trigger is detached and the elasticity of the fishing rod tugs the fishing line and sets the hook.

The current application claims a priority to the U.S. Provisional Patent application Ser. No. 61/762,048 filed on Feb. 7, 2013.

### FIELD OF THE INVENTION

The present invention relates generally to fishing equipment. More specifically, to an automatic hook setting device that is triggered upon detection of a bite on a fishing line.

### BACKGROUND OF THE INVENTION

Ice fishing is a popular pastime due to its enjoyable and relatively straightforward nature. The sport of ice fishing generally involves opening a hole in the surface of the ice into which a fishing line is inserted. Fishermen typically hold their fishing rods manually or place the rods into fishing rod holders for hands-free operation. The latter configuration allows fishermen to fish with multiple fishing rods to cover a greater surface area and thus increase chances of catching fish. Effective fishing rod holders retain a fishing rod in a stabilized, easily accessible position for fishermen. Stability in a fishing rod holder is integral as a bite from a large fish can violently jerk a fishing rod from its holder, potentially causing damage to the fishing rod and/or causing the fishing rod to become lost. To increase the chances of catching fish, many fishermen opt to fish with multiple fishing lines baited and set in the water. While having more fishing lines set in the water should increase the chances of catching more fish, the multiple fishing lines are difficult to attend to and monitor. This disadvantage is further exacerbated by spacing each baited line out over a large area. As a result, many fish are often lost since a fisherman maybe unable to set the hook while a fish is biting.

While the drawback of setting a hook when fishing with multiple fishing lines is well known to those familiar with the sport of ice fishing, attempts to improve this situation with various apparatuses have had mediocre results at best. Current apparatuses used for automatically setting a fishing hook rely on a spring operated trigger system. These systems are generally referred to as tip up systems and comprise a beam that crosses an ice fishing hole, a spring loaded arm, and a tension activated trigger coupled to a fishing line. The beam retains the system in place as well as positions the baited fishing line in the water. The tension activated trigger and the spring arm are cooperatively engaged with a baited fishing line. The spring loaded arm is coupled to the baited fishing line and elastically retained by the tension activated trigger. The baited fishing line is operatively coupled to the trigger where upon the tugging of the fishing line by a biting fish actuates the trigger releasing the spring loaded arm. The spring loaded arm tugs on the fishing line and sets the hook. Although these systems are sometimes able to automatically set a baited fishing hook, they suffer from several disadvantages. One disadvantage is that basic configurations of these systems are difficult to set up and use with a fisherman's existing or preferred fishing rod. Another disadvantage is that basic configurations of these systems are unable to adequately adjust the sensitivity of the trigger system to accommodate different fishing conditions.

It is therefore the object of the present invention to provide a hook setting trigger device that automatically sets a fishing hook when a fishing line is tugged by a biting fish. The hook setting trigger utilizes a fisherman's existing or preferred fishing rod set up. The hook setting trigger is able to adjust the sensitivity of the trigger. The hook setting trigger functions complimentarily with a stabilizing base that retains the fishing rod and an anchored tether to flexes the fishing rod. The stabilizing base contains a fishing rod holder that retains a fishing rod in an upright position and allows a fisherman to set the tension of a fishing rod prior to inserting the fishing line into the water. The fishing rod is placed into the fishing rod retainer and securely held in place. The fishing rod retainer prevents the fishing rod from being violently jerked out of the holder by large fish. The tether retains the trigger at a fixed distance. The fisherman flexes the fishing rod and mounts to the hook setting trigger to the terminal eyelet of the fishing rod. A baited fishing line is operatively coupled to the trigger and then positioned in the water. During the course of ice fishing, a bite on the fishing line causes the hook setting trigger to separate from terminal eyelet of the fishing rod. This separation causes the fishing rod to snap upwards from a tense position to a relaxed position. The sudden motion pushes the hook barb into the fish's mouth and greatly increases the chances of reeling in the fish.

### BRIEF DESCRIPTIONS OF THE DRAWINGS

FIG. 1 is a perspective view displaying the hook setting trigger operatively coupled to a flexed fishing rod as per the current embodiment of the present invention.

FIG. 2 is an enhanced view displaying the hook setting trigger operatively coupled to a flexed fishing rod as per the current embodiment of the present invention.

FIG. 3 is a lateral view displaying the component arrangement of the hook setting trigger as per the current embodiment of the present invention.

FIG. 4 is a lateral view displaying the component distribution of the hook setting trigger relative to a vertical axis as per the current embodiment of the present invention.

FIG. 5 is a perspective view displaying the front upper regions of the hook setting trigger as per the current embodiment of the present invention.

FIG. 6 is a perspective view displaying the lower rear regions of the hook setting trigger as per the current embodiment of the present invention.

FIG. 7 is an enhanced view displaying the tether pivotably couple to the low tension notch as per the current embodiment of the present invention.

FIG. 8 is an enhanced view displaying the tether pivotably couple to the high tension notch as per the current embodiment of the present invention.

FIG. 9 is a lateral view displaying the actuation of the hook setting trigger as per the current embodiment of the present invention.

FIG. 10 is a lateral view displaying the flexed fishing rod having set the hook on a biting fish as per the current embodiment of the present invention.

FIG. 11 is a lateral view displaying the approximate measurements of the hook setting trigger as per the preferred embodiment of the present invention.

### DETAIL DESCRIPTIONS OF THE INVENTION

All illustrations of the drawings are for the purpose of describing selected versions of the present invention and are not intended to limit the scope of the present invention.

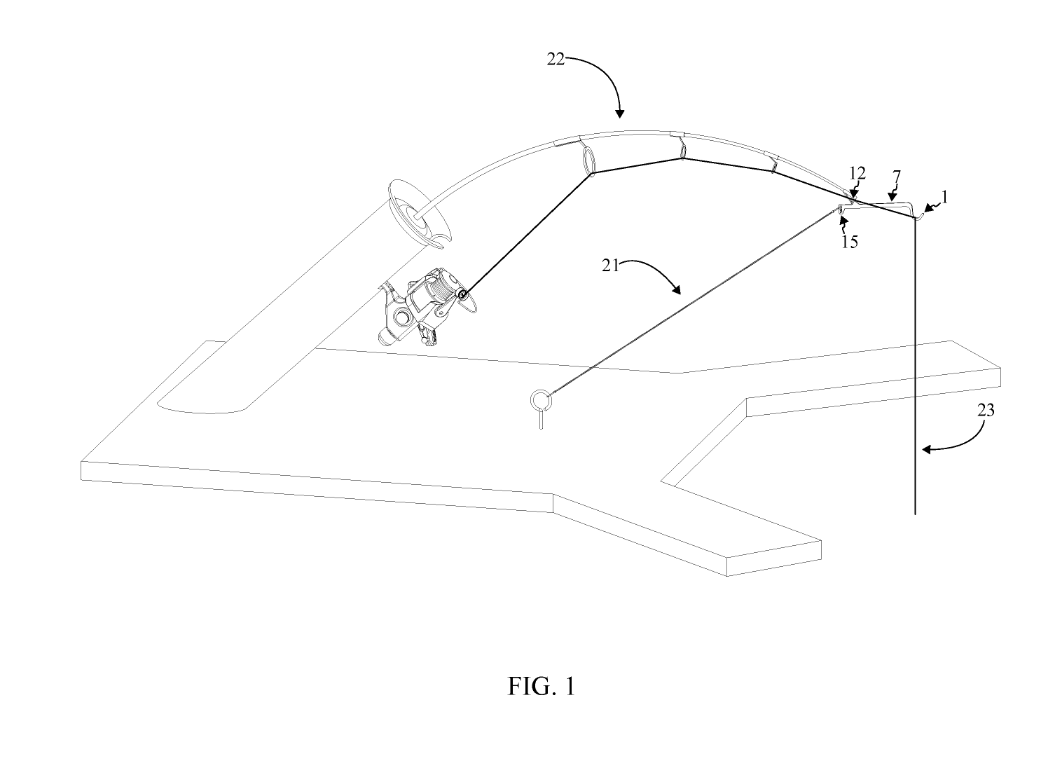

Referencing FIG. 1, the present invention is a hook setting trigger utilized in an ice fishing set up that automatically sets a hook when the fishing line 23 is tugged by a biting fish. The hook setting trigger comprises a line catch 1, an elongated body 7, an eyelet mount 12, a tension adjuster 15, and a tether 21. The line catch 1 is a curved structure similar to a j-hook that engages a fishing line 23 hanging in the water and functions as the actuation point for the hook setting trigger. The elongated body 7 is a rigid structural element that distributes the eyelet mount 12, the line catch 1, and the tension adjuster 15 in a particular balanced arrangement. The eyelet mount 12 is a structure that permits the hook setting trigger to pivotably and detachably engage the guide ring or eyelet of a fishing rod 22. The tension adjuster 15 is an engageable structure that pivots the hook setting trigger about the eyelet mount 12 allowing adjustment of the sensitivity of the fishing line 23 pull to actuate the hook setting trigger. The tether 21 is an anchored line detachably coupled to the tension adjuster 15 that is used to keep the fishing rod 22 flexed.

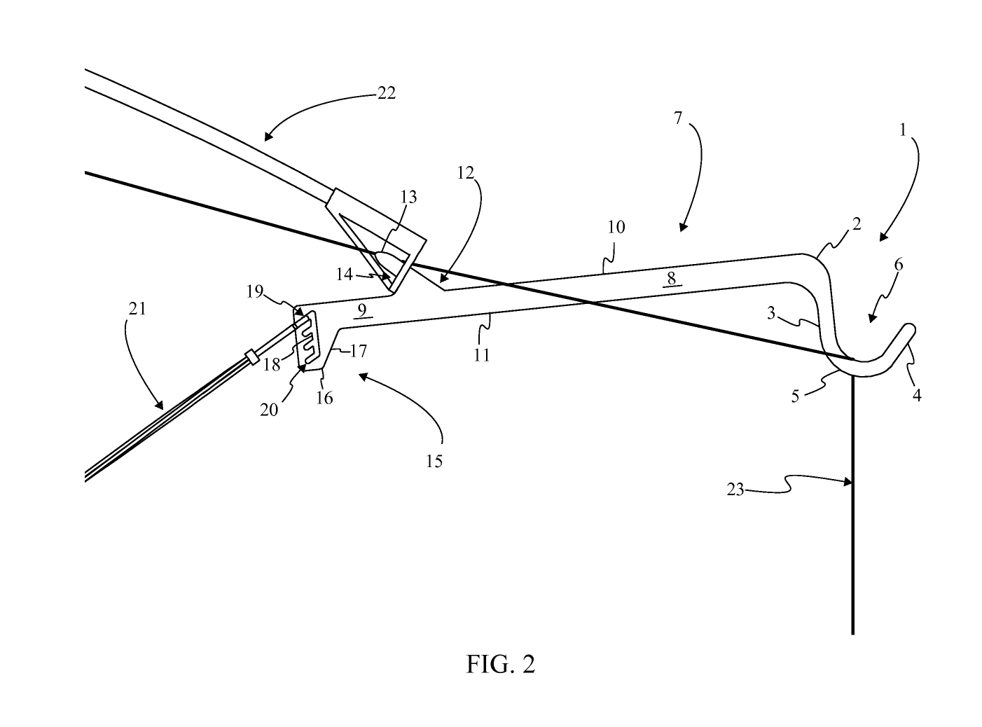

Referencing FIG. 2-4, the line catch 1 is a hook shaped component that extends from an end of the elongated body 7 opposite the tension adjuster 15. The line catch 1 interacts with a baited fishing line 23 dangling in the water and primarily functions as the actuation point for the hook setting trigger. The line catch 1 has a thickness that is less than the elongated body 7. The edges of the line catch 1 are provided with a smooth finish in order to reduce wear to the fishing line 23. In the current embodiment of the present invention, the line catch 1 comprises a rounded corner 2, a shank 3, a bend 5, a gap 6, and an end section 4. The rounded corner 2 is a beveled edge that joins the elongated body 7 to the line catch 1. The shank 3, the bend 5, and the end section 4 provide the line catch 1 with its hook shape. The shank 3 is a protruding section that positions the bend 5 away from the elongated body 7. The bend 5 is the curved section that is connected the shank 3 and the end section 4. The bend 5 becomes coincident with the fishing line 23. The end section 4 extends tangentially to the bend 5 and functions to keep the fishing line 23 within the gap 6. The gap 6 is a cavity 14 formed between the shank 3 and the end section 4 that allows the fishing line 23 to engage the bend 5.

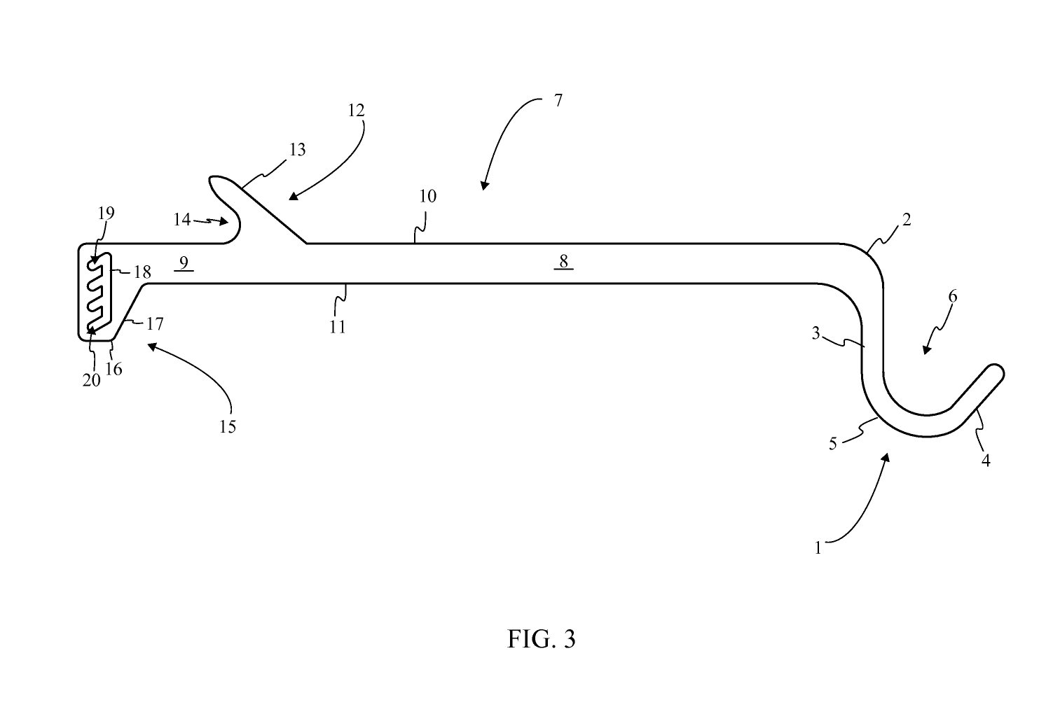

Referencing FIG. 2 and FIG. 3, the rounded corner 2 is a structural feature joining the line catch 1 and the elongated body 7. The rounded corner 2 provides a beveled edge between an upper surface 10 of the elongated body 7 and a coincident surface on the shank 3. The rounded corner 2 provides a transition between the thickness of the elongated body 7 and the line catch 1. The rounded corner 2 allows a fishing line 23 being set in the bend 5 of the hook setting trigger to roll over the beveled edge. The rounded corner 2 reduces wear on a fishing line 23 by reducing contact between the fishing line 23 and the elongated body 7. The rounded corner 2 mounts the first section 8 of the elongated body 7 with the shank 3 at a particular angle. The particular angle between the first section 8 and the shank 3 aligns the bend 5 and the end section 4 with a fishing line 23 while the hook setting trigger is in a high tension or a low tension arrangement.

Referencing FIG. 2 and FIG. 3, the shank 3 is an elongated section of the line catch 1 that is joined to the rounded corner 2 and the bend 5. The shank 3 functions complimentarily with the bend 5 and the end section 4 in order to form the gap 6. The shank 3 is positioned adjacent to a lower surface 11 of the elongated body 7. The length of the shank 3 positions the bend 5 and the end section 4, and subsequently the gap 6, at a particular distance from the elongated body 7. The edges of the shank 3 are contacted by the fishing line 23. The fishing line 23 contacts the edges of the shank 3 while the fishing line 23 is set in the bend 5. The fishing line 23 curves around the shank 3 in order to become coincident with the bend 5. The thickness of the line catch 1 changes at the rounded corner 2 and is noticeable at the shank 3. The shank 3 has a thickness that is less than the elongated body 7. The shank 3 has a thickness that is relatively similar to the bend 5 and the end section 4.

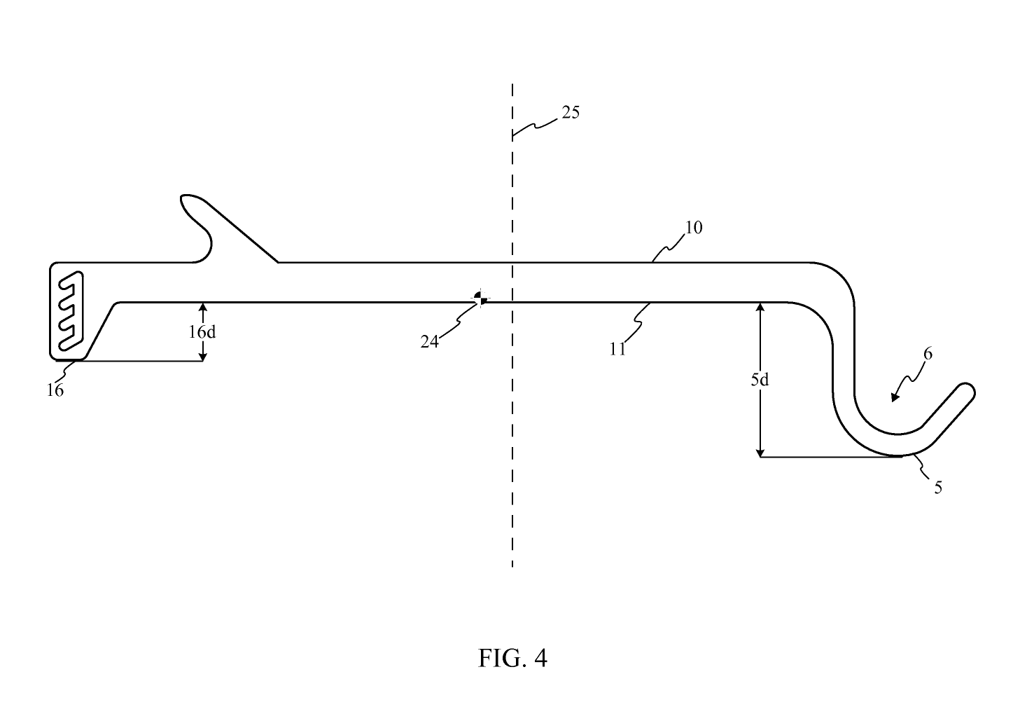

Referencing FIG. 3 and FIG. 4, the bend 5 is the curved section of the line catch 1 that contacts the fishing line 23. The bend 5 is positioned between the shank 3 and the end section 4. The bend 5 is directionally opposed to the rounded corner 2, wherein the concavity 14 of the bend 5 is opposite the concavity 14 of the rounded corner 2. The curvature of the bend 5 aligns the end section 4 at a particular angle to the shank 3. The particular angle between the end section 4 and the shank 3 positions the curvature of the bend 5 as the lowest point of the gap 6 when the hook setting trigger is mounted to a fishing rod 22. A fishing line 23 set in the line catch 1 curves around the shank 3, traversing across the upper portion of the bend 5. The fishing line 23 then curves around the bend 5 at a downward angle towards the water. The bend 5 is pulled at a downward angle by a fish striking a bait on a fishing line 23. The pull felt by the bend 5 is transferred about the eyelet mount 12 resulting in the hook setting trigger disengaging from the eyelet of a flexed fishing rod 22. The disengagement of the hook setting trigger from the flexed fishing rod 22 causes the fishing rod 22 to return to a relaxed state pulling the fishing line 23 and setting the hook.

Referencing FIG. 3 and FIG. 4, the end section 4 is the terminal portion of the line catch 1. The end section 4 is disposed away from the shank 3, wherein the end section 4 extends tangentially from the bend 5 away from the shank 3. The end section 4 assists in maintaining a fishing line 23 coincident with the bend 5 by being sloped towards the center of the bend 5. The end section 4 is rounded at its terminal end. The end section 4 is provided with sufficient length allowing the gap 6 to be adequately surrounded in various pivotal alignments while the hook setting trigger is mounted to a flexed fishing rod 22.

Referencing FIG. 3 and FIG. 4, the gap 6 is a concavity 14 surrounded by the shank 3, the bend 5, and the end section 4. The gap 6 is the space through which the fishing line 23 traverse in order to become coincident with the bend 5. The gap 6 is generally parabolic in shape as a result of the positioning of the shank 3 and the end section 4 relative to the bend 5. The gap 6 indirectly aligns with a fishing line 23, as a fishing line 23 has to curve about the shank 3 to enter the gap 6.

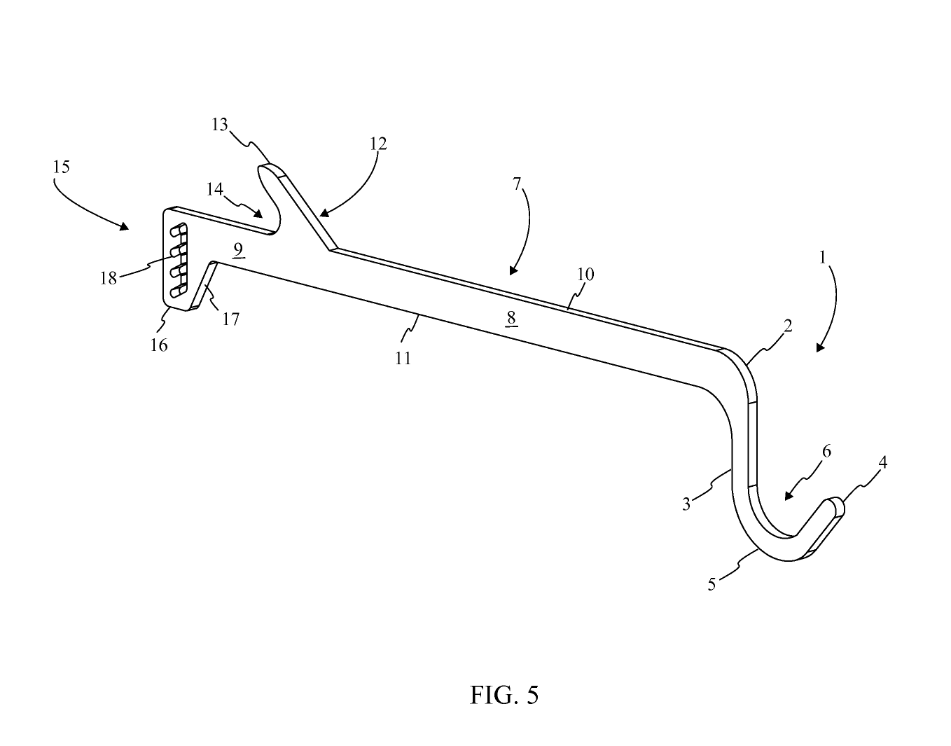

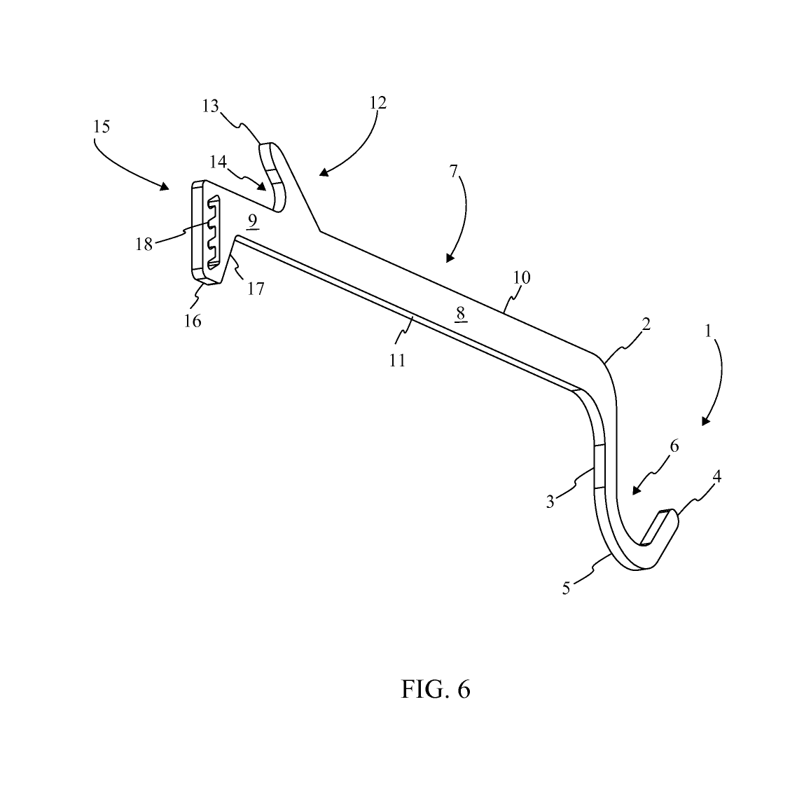

Referencing FIG. 2, FIG. 5, and FIG. 6, the elongated body 7 is a rigid structural body that distributes the eyelet mount 12, the line catch 1, and the tension adjuster 15 in a particular balanced arrangement. The elongated body 7 is positioned between the line catch 1 and the tension adjuster 15. The line catch 1 and the tension adjuster 15 are positioned at opposite ends of the elongated body 7. The eyelet mount 12 is positioned adjacent to the elongated body 7 proximal to the tension adjuster 15. In the current embodiment of the present invention the elongated body 7 is generally rectangular in shape. The elongated body 7 comprises a first section 8, a second section 9, an upper surface 10, and a lower surface 11. The first section 8 is the portion of the elongated body 7 that is demarcated between the engagement of the rounded corner 2 and the engagement of the eyelet mount 12. The second section 9 is portion of the elongated body 7 that is demarcated between the eyelet mount 12 and the tension adjuster 15. The upper surface 10 is coincident with both the first section 8 and the second section 9 and is found coincident with the eyelet mount 12. The lower surface 11 is found positioned opposite the upper surface 10 and is found adjacent with the positioning of the shank 3 and an extended area 16 of the tension adjuster 15.

Referencing FIG. 2, FIG. 5, and FIG. 6, the first section 8 is the region of the elongated body 7 that is coincident with the rounded corner 2 of the line catch 1. The first section 8 is similar in thickness to the second section 9 as the thickness of the elongated body 7 is generally uniform. The first section 8 contacts the fishing line 23 set in the line catch 1 about an edge coincident the upper surface 10 and across a lateral surface. It should be noted that the first section 8 does not operatively couple the fishing line 23. The first section 8 positions the line catch 1 at a particular distance from the eyelet mount 12.

Referencing FIG. 2, FIG. 5, and FIG. 6, the second section 9 is positioned between the eyelet mount 12 and the tension adjuster 15. The second section 9 positions the tension adjuster 15 at a particular distance to the eyelet mount 12. The tension adjuster 15 partially tapers into the second section 9. The second section 9 and the first section 8 are positioned collinearly to one another. In the current embodiment of the present invention, the second section 9 is shorter than the first section 8 positioning the eyelet mount 12 proximally to the tension adjuster 15. The distance between the eyelet mount 12 and the tension adjuster 15 provided by the second section 9 provides a bias towards the line catch 1 facilitating actuation of the hook setting trigger by a fishing line 23.

Referencing FIG. 2, and FIG. 4-6, in the current embodiment of the present invention, the first section 8 is provided as being sufficiently longer than the second section 9. The length of the first section 8 being sufficiently longer than the second section 9 enables a center of mass 24 for the hook setting trigger to be found in the first section 8. With the center of mass 24 positioned within the first section 8, the hook setting trigger facilitates the actuation of the hook setting trigger when pulled by a fishing line 23. In the preferred embodiment of the present invention, the center of mass 24 is found positioned on the first section 8 proximal to the lower surface 11. The proximal position of the center of mass 24 to the lower surface 11 facilitates the disengagement of the eyelet mount 12 from the eyelet of a flexed fishing rod 22 by being slightly biased in the same direction as the pull of the fishing line 23.

Referencing FIG. 2, FIG. 5, and FIG. 6, the upper surface 10 is a surface of the elongated body 7 that is coincident with both the first section 8 and the second section 9. The upper surface 10 is positioned opposite the lower surface 11 across the elongated body 7. The upper surface 10 runs parallel to the lower surface 11 along the length of the elongated body 7. The upper surface 10 is coincident with the eyelet mount 12. The eyelet mount 12 separates the upper surface 10 into two areas coincident with the first section 8 and the second section 9. The upper surface 10 is coincident with the rounded corner 2. The upper surface 10 is beveled by the rounded corned becoming coincident with a complimentary section on the shank 3.

Referencing FIG. 2, FIG. 5, and FIG. 6, the lower surface 11 is a surface of the elongated body 7 that is positioned opposite the upper surface 10. The lower surface 11 is coincident with the line catch 1 and the tension adjuster 15. It should be noted that the lower surface 11 is coincident with the first section 8 and the second section 9 although no distinguishable demarcation is present. The lower surface 11 runs parallel to the upper surface 10. The lower surface 11 is positioned adjacent to the shank 3. The shank 3 extends from the rounded corner 2 away from the upper surface 10 positioning the shank 3 proximal to the lower surface 11 along a vertical axis. Similarly, an extended area 16 of the tension adjuster 15 is positioned adjacent to the lower surface 11, as the extended area 16 is protrudes away from the upper surface 10 having the majority of the feature proximal to the lower surface 11 along a vertical axis. A tapered section 17 of the extended area 16 is disposed towards the lower surface 11, wherein the thickness of the tapered section 17 diminishes as it approaches the lower surface 11.

Referencing FIG. 2, and FIG. 4-6, in the current embodiment of the present invention the upper surface 10 and the lower surface 11 are positioned perpendicular with the shank 3. The perpendicular arrangement between the shank 3 and the upper surface 10 positions the bend 5 and the end section 4 at a particular angle experimentally determined to operatively engage a fishing line 23 while the hook setting trigger is pivotably positioned with the eyelet of a flexed fishing rod 22. The particular angle enables the bend 5 to be operatively engaging the fishing line 23 regardless of the pivotable positioning of the hook setting trigger. The operative engagement permits a user to set a fishing line 23 coincident with the bend 5 in a manner that allows a pull of the fishing line 23 by a biting fish to disengage the eyelet mount 12 from the eyelet of a flexed fishing rod 22.

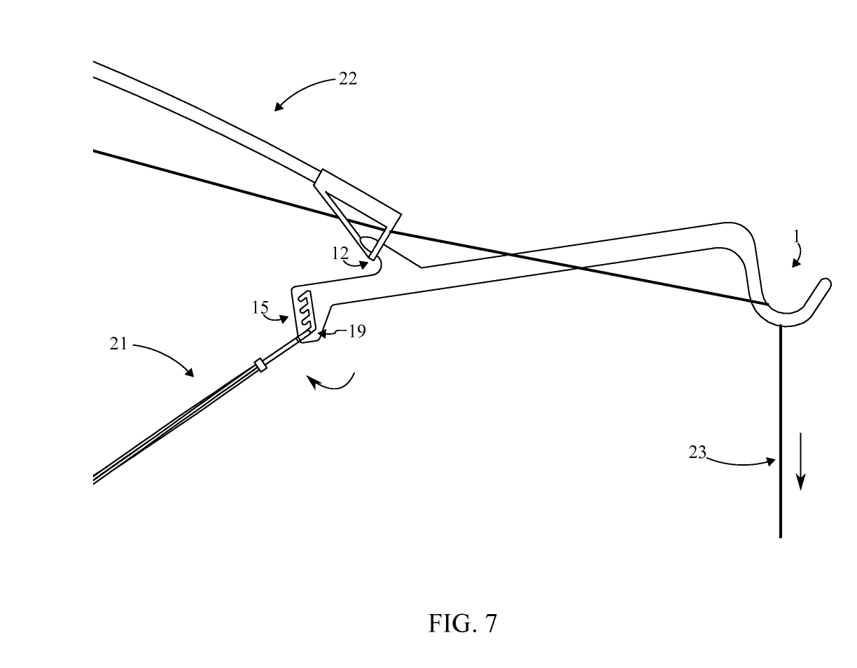

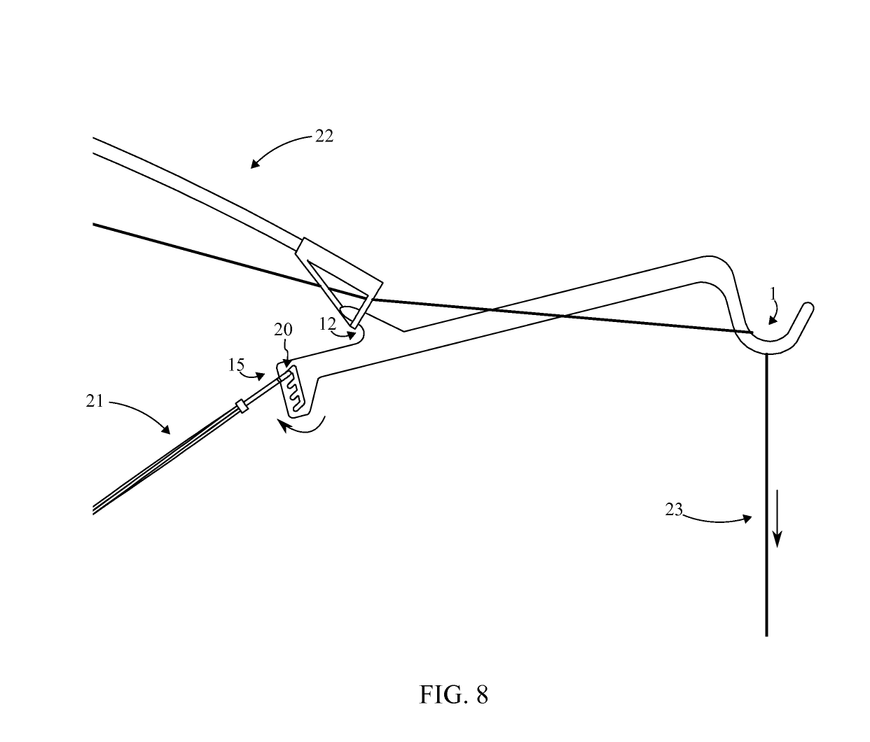

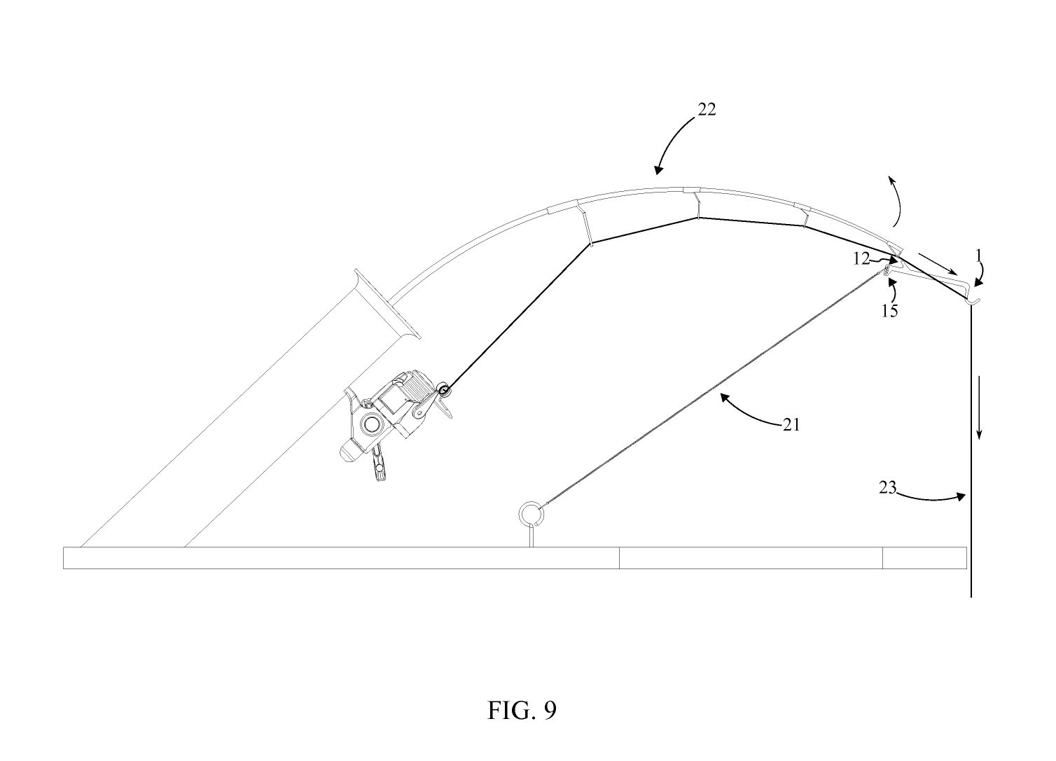

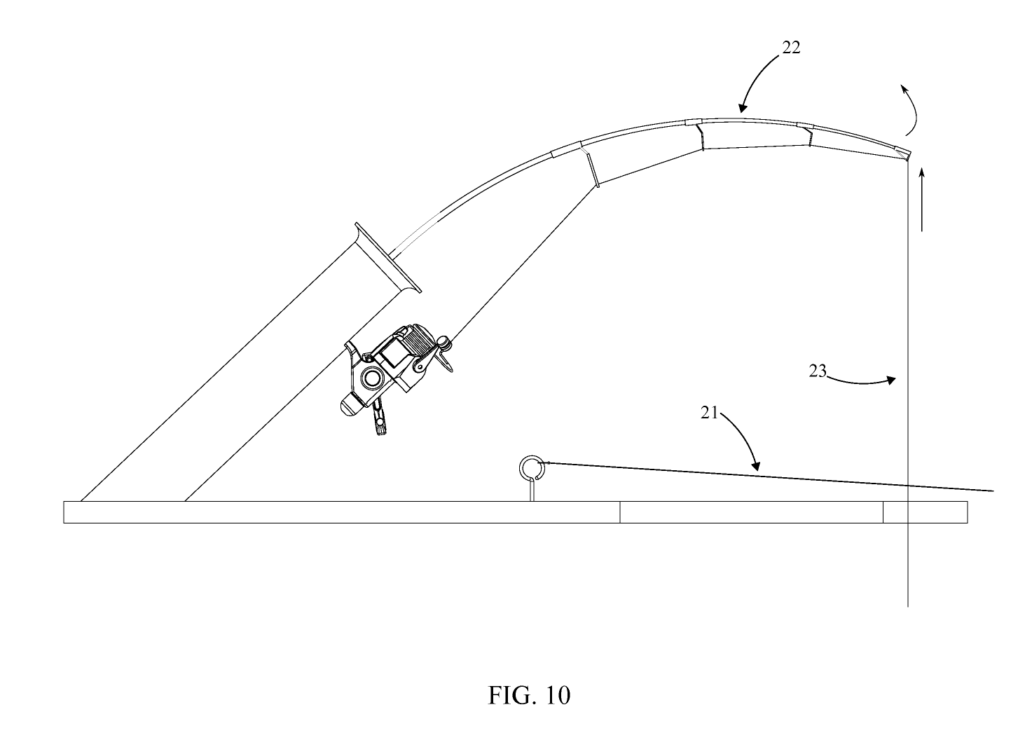

Referencing FIG. 1-3, and FIG. 7-10, the eyelet mount 12 engages the eyelet of a flexed fishing rod 22 in order to actuateably mount the hook setting trigger. The eyelet mount 12 partly traverse into the eyelet or guide ring of a fishing rod 22. The eyelet mount 12 is retained against the eyelet of a flexed fishing rod 22 by the engagement of the tether 21 with the tension adjuster 15. The eyelet mount 12 is pivotable about the rim of the eyelet varying the angular positioning of the line catch 1 relative to the horizontal. The angular positioning of the line catch 1 relative to the horizontal increase or decreases the pull force required to actuate the hook setting trigger. The eyelet mount 12 is found coincident with the upper surface 10 of the elongated body 7. The eyelet mount 12 is positioned proximal to the tension adjuster 15. The proximal positioning of tension adjuster 15 balances the hook setting trigger when mounted to a flexed fishing rod. In the current embodiment of the present invention, the eyelet mount 12 comprises a protruding body 13 and a cavity 14. The protruding body 13 is a structure that traverses into an eyelet of a flexed fishing rod 22. The cavity 14 is a curved feature that contacts the rim of an eyelet permitting facilitated detachment of the eyelet mount 12 with the flexed fishing rod 22 when the hook setting trigger is actuated by the pull of a fishing line 23.

Referencing FIG. 2-3 and FIG. 5-6, the protruding body 13 is a structure that traverses the eyelet of a flexed fishing rod 22 in order to mount the hook setting trigger. The protruding body 13 projects from the upper surface 10 with a bias towards the tension adjuster 15. The bias towards the tension adjuster 15 positions the protruding body 13 with an angular measurement that is less than 90° to the second section 9. The bias towards the tension adjuster 15 allows the protruding body 13 to traverse into the eyelet of a flexed fishing rod 22 while having the elongated body 7 in a mostly horizontal alignment. The angular positioning of the protruding body 13 allows the cavity 14 to be retained against the rim of the eyelet permitting the pivotable movement of the line catch 1 to actuate the hook setting trigger disengaging the eyelet mount 12 from fishing rod 22. The protruding body 13 tapers towards the terminal end. The protruding body 13 is mostly smooth in order to prevent unwanted interaction with the eyelet.

Referencing FIG. 2-3 and FIG. 5-6, the cavity 14 is a curved feature positioned between the upper surface 10 of the second section 9 and the protruding body 13. The cavity 14 pivotably and detachably engages the rim of the eyelet of a flexed fishing rod 22. The cavity 14 is retained against the rim of an eyelet by the detachable coupling of the tether 21 to the tension adjuster 15. The curvature of the cavity 14 facilitates the detachment of the eyelet mount 12 from the flexed fishing rod 22 by pivoting the protruding body 13 about the rim when pulled by the fishing line until the protruding body 13 is able to slide out of the eyelet. The cavity 14 pivots about the engagement of the eyelet of the flexed fishing rod 22. The pivotable engagement of the cavity 14 permits the angular positioning of the line catch 1 to vary about said pivotably engagement. The angular positioning of the line catch 1 is inversely related to the sensitivity required for actuating the hook setting trigger, wherein the greater the angular positioning of the line catch 1 the lower the sensitivity for actuating the hook setting trigger.

Referencing FIG. 2-3 and FIG. 5-9, the tension adjuster 15 is a structural feature positioned opposite the line catch 1 on the elongated body 7. The tension adjuster 15 is detachably and pivotably coupled to the tether 21. The tension adjuster 15 is provided as a means of varying the sensitivity of the hook setting trigger. The tension adjuster 15 accomplishes this by varying the distance between the cavity 14 and the pivotable engagement with the tether 21. The greater the distance between the cavity 14 and pivotable engagement with the tether 21, the lower pull force required by a fishing line 23 with the line catch 1 is needed to actuate the hook setting trigger. The tension adjuster 15 is positioned adjacent to the second section 9. The tension adjuster 15 is positioned proximal to the eyelet mount 12. The positioning of the tension adjuster 15 near the eyelet mount 12 centers most of the weight of the hook setting trigger near the pivotable engagement with the flexed fishing rod 22 facilitating actuation of the hook setting trigger by the line catch 1. In the current embodiment of the present invention, the tension adjuster 15 comprises an extended area 16 and a plurality of adjustment notches 18. The extended area 16 is an expanded portion of the tension adjuster 15 that accommodates the positioning of the plurality of adjustment notches 18. The plurality of adjustment notches 18 are provided as engageable openings that varies the sensitivity for actuating the hook setting trigger.

Referencing FIG. 2-4 and FIG. 5-6, the extended area 16 is positioned adjacent to the lower surface 11. The extended area 16 is traversed by the plurality of adjustment notches 18. The extended area 16 increases the size of the tension adjuster 15. The increased size of the tension adjust accommodates the plurality of adjustment notches 18. The increased size additionally adds weight to the tension adjuster 15 allowing the tension adjuster 15 to function as a counter balance to the line catch 1. The added weight helps center the balance of the hook setting trigger near the eyelet mount 12 when engaged with a flexed fishing rod 22. In the current embodiment of the present invention, the extended area 16 comprises a tapered section 17. The tapered section 17 is disposed towards the lower surface 11 of the elongated body 7, wherein the tapered section 17 diminishes in size as it approaches the lower surface 11. The tapered section 17 allows the extended section 16 to have a compact profile while being able to functioning as a counter balance for the line catch 1.

Referencing FIG. 2-3 and FIG. 7-10, the plurality of adjustment notches 18 are a series of engagement point for the tether 21 that influence the sensitivity for actuating the hook setting trigger. The plurality of adjustment notches 18 traverse the extended area 16 of the tension adjuster 15. The plurality of adjustment notches 18 are detachably and pivotably coupled to the tether 21. The engagement between the tether 21 and the plurality of adjustment notches 18 pivots the hook setting trigger out of engagement with the eyelet of the flexed fishing rod 22. The specific positioning between the tether 21 and the plurality of adjustment notches 18 varies sensitivity for actuating the hook setting trigger. In the current embodiment of the present invention, the plurality of adjustment notches 18 comprises a low sensitivity notch 19 and a high sensitivity notch 20. The low sensitivity notch 19 is diametrically opposed from the low sensitivity notch 19. The low sensitivity notch 19 is found positioned proximal to the second section 9. The engagement of the tether 21 with the low sensitivity notch 19 provides a shorter distance with the eyelet mount 12 relative to the high sensitivity notch 20 and the eyelet mount 12. The closer the pivotable engagement of the tether 21 with the plurality of adjustment notches 18 to the cavity 14, the greater the vertical pull force required from the fishing line 23 coincident with the line catch 1 to disengage the eyelet mount 12 from the flexed fishing rod 22.

Referencing FIG. 1-2 and FIG. 7-10, the tether 21 is detachably coupled to the plurality of adjustment notches 18. The tether 21 retains the hook setting trigger with a flexed fishing rod 22. The tether 21 is anchored to a fixed point that allows the hook setting trigger to retain the flexed fishing rod 22. The tether 21 pivotably and detachably engages the plurality of adjustment notches 18. The particular engagement point of the tether 21 with the plurality of adjustment notches 18 varies the sensitivity of actuation of the hook setting trigger. The greater the distance between the cavity 14 and the pivotable engagement of the tether 21 with the plurality of adjustment notches 18, the weaker the vertical pull force required to actuate the hook setting trigger. In the current embodiment of the present invention, the tether 21 is provided with reduced elasticity and is anchored to a fixed location.

Referencing FIG. 2-6, in the preferred embodiment of the present invention, the bend 5 is positioned further from the lower surface 11 than the extended area 16 relative to a vertical axis 25 positioned perpendicular to the upper surface 10 and the lower surface 11. The distance 5d between the bend 5 and the lower surface 11 is greater than the distance 16d between the extended section 16 and the lower surface 11. The positioning of the bend 5 relative to lower surface 11 decreases the distance required to pivot the line catch 1 in order to disengage the hook setting trigger from the flexed fishing rod 22.

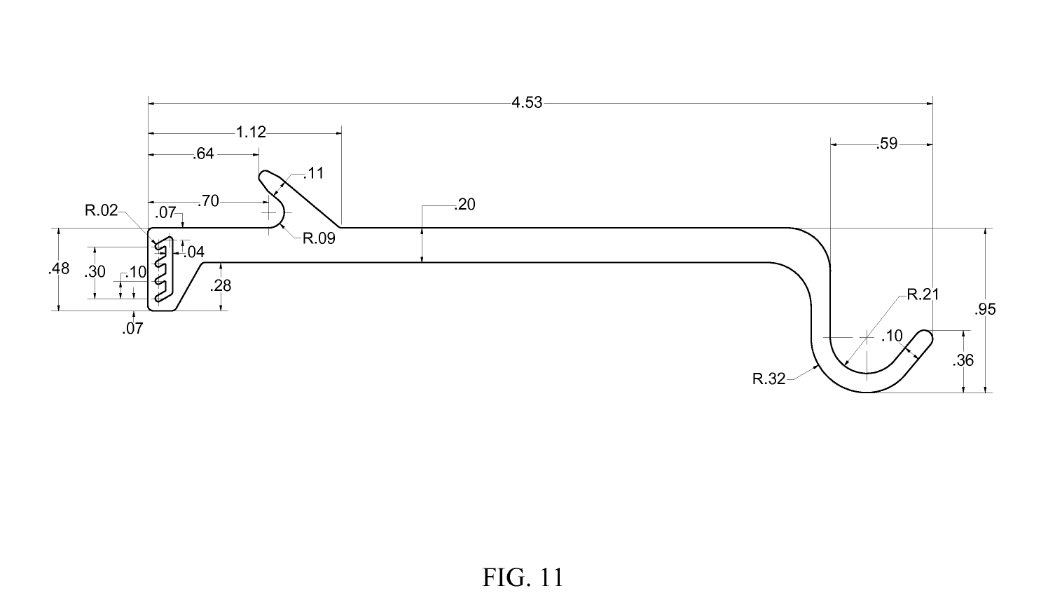

Referencing FIG. 3 and FIG. 11, in the preferred embodiment of the present invention, the hook setting trigger is provided with a length of 4.53″, wherein the length is measured from the tip of the end section 4 to the end face of the tension adjuster 15. The hook setting trigger is provided with a height 1.28″, wherein the height is measured from the bend 5 to the top most portion of the protruding body 13. The hook setting trigger is provided with a uniform thickness of 0.059″. The end section 4 is provided with a thickness of 0.10″. The distance between the shank 3 and the tip of the end section 4 is 0.59″. The height of the line catch 1 from the upper surface 10 to the bend 5 is 0.95″. The height between the bend 5 and the tip of the end section 4 is 0.36″. The bend 5 has an interior radial curvature of 0.21″ while the exterior curvature of the bend 5 is 0.32″. The elongated body 7 has a height of 0.20″, wherein the height of the elongated body 7 is measured between the upper surface 10 and the lower surface 11. The tip of the protruding body 13 is found 0.64″ from the end face of the tension adjuster 15. The coincident point between the eyelet mount 12 and the first section 8 is positioned 1.12″ from the end face of the tension adjuster 15. The curvature of the cavity 14 has a radial measurement of 0.09″ from a center point positioned 0.70″ from the end face of the tension adjuster 15. The protruding body 13 has a thickness of 0.11″. The tension adjuster 15 has a height of 0.48″, wherein the height is measured from the extended section 16 to the upper surface 10. The extended section has a height of 0.28″, wherein the height of the extended section 16 is measured from the lower surface 11. The plurality of adjustment notches 18 are positioned 0.70″ from the upper surface 10, 0.70″ from the bottom edge of the extended section 16, and 0.70″ from the end face of the tension adjuster 15. The distance between an adjustment notch of the plurality of adjustment notches 18 to another adjustment notch of the plurality of adjustment notches 18 is 0.10″. The interior curvature of each adjustment notch of the plurality of adjustment notches 18 has a radial measurement of 0.02″. The high sensitivity notch 20 is positioned 0.30″ from the low sensitivity notch 19.

In the current embodiment of the present invention, the hook setting trigger is provided with a weight of approximately 0.25 oz. It should be noted that that while current embodiment is provided with the aforementioned weight that additional embodiments may be scaled appropriately to interact with a different fishing set ups.

In an embodiment of the present invention is a fishing rod 22 holder that both retains a fishing rod 22 in an upright position and allows a user to set the fishing rod 22 tension prior to use for the purpose of automatically hooking a biting fish. In its preferred embodiment, the present invention comprises a stabilizing base, a fishing rod 22 retainer, a tether 21, and a hook setting trigger.

In an embodiment of the present invention, a stabilizing base comprises a rectangular flat extrusion of material forming a platform with a first side, a second side, a first end, and a second end. The first side of the platform is slightly elevated by means of three extrusions of material forming feet. The first end of the platform's first side is elevated by one foot while the second end of the platform's first side is elevated by two feet. These two feet are angled to provide stability to the base in the event of a sudden motion. The first end of the platform's second side comprises a tubular extrusion of material forming a fishing rod 22 retainer. The fishing rod 22 retainer is angled towards the second end of the platform and is sized such that a conventional fishing rod 22 may be slotted into the retainer.

In an embodiment of the present invention, the tether 21 is looped and mounted at two points. The first mounting point is present at the second end of the platform's second side. The second mounting point is the tension adjuster 15 of the hook setting trigger that is attached to a fishing rod 22. The tether's 21 length is adjustable by using a quick release clip present along the length of the tether 21 to shorten the length of tether 21 present between the two mounting points. The first mounting point may differ in various embodiments of the present invention. In an embodiment, the tether 21 is attached directly to the stabilizing base.

In an embodiment of the present invention, a hook setting trigger comprises an elongated body 7 with a first section 8 and a second section 9. The first section 8 of the hook setting trigger comprises a line catch 1. The line catch 1 is sized such that a fishing line 23 may be threaded through a gap 6. The second section 9 of the hook setting trigger comprises a tension adjuster 15 for attaching the tether 21. A protrusion of material is featured adjacent to the second section 9 to allow the hook setting trigger to be attached to an eyelet on a fishing rod 22. The hook setting trigger is available in various configurations. The present invention is not limited with respect to material of the hook setting trigger. However, in the preferred embodiment of the present invention, the hook setting trigger is composed of a material such as aluminum, stainless steel, or galvanized steel.

The present invention is used in conjunction with a conventional fishing rod 22 and fishing line 23. In an embodiment of the present invention, a fishing rod 22 is slotted into the tubular fishing rod 22 retainer present on the stabilizing base. The hook setting trigger is attached to the tether 21. The tether 21 is in turn mounted to the stabilizing base. The hook setting trigger is attached to the eyelet of the fishing rod 22 present at the end of the fishing rod 22 by slotting the protrusion of material adjacent to the second section 9 of the hook setting trigger into the terminal eyelet of the fishing rod 22. The length of the tether 21 is adjusted to set the tension of the fishing rod 22. The fishing line 23 is placed over and in direct contact with the hook setting trigger. The fishing line 23 is then inserted into the opening in the ice. The force from a fish bite on the fishing line 23 causes the hook setting trigger to dislodge and separate from the eyelet of the fishing rod 22. The separation subsequently removes the tension in the flexed fishing rod 22 from the tether 21. This causes the fishing rod 22 to snap upwards from a flexed position to a relaxed position. This sudden movement of the fishing rod 22 and fishing line 23 sets the hook into the fish's mouth, decreasing the likelihood of the fish escaping. The user is then able to reel in the caught fish as normal. The fishing rod 22 retainer holds the fishing rod 22 in place and prevents movement while the feet of the stabilizing base prevent the present invention from moving. In an embodiment of the present invention, the release of the hook setting trigger from the fishing line 23 guide causes the metallic swivel joint of the tether 21 to move in a downward direction.

In addition to providing autonomous hook setting into a biting fish's mouth, the present invention holds fishing rods 22 in a stabilized, upright position off of the ice during the ice fishing process. This allows fishermen to conveniently ice fish with multiple fishing rods 22.

Although the invention has been explained in relation to its preferred embodiment, it is to be understood that many other possible modifications and variations can be made without departing from the spirit and scope of the invention as hereinafter claimed.

What is claimed is:

1. A hook setting trigger comprises:
a line catch;
an elongated body;
an eyelet mount;
a tension adjuster;
a tether;
the line catch comprises an rounded corner, a shank, a bend, a gap and an end section;
the elongated body comprises a first section, a second section, an upper section, and a lower section;
the eyelet mount comprises a protruding body and a cavity;
the tension adjuster comprises an extended area and a plurality of adjustment notches;
the extended area comprises a tapered section;
the elongated body being positioned between the tension adjuster and the line catch;
the eyelet mount being adjacently positioned to the elongated body;
the eyelet mount being proximal to the tension adjuster;
the first section being positioned between the eyelet mount and the rounded corner;
the second section being positioned between the tension adjuster and the eyelet mount;
the eyelet mount being positioned coincident with the upper surface;
the protruding body projects out of the upper surface biased towards the tension adjuster;
the cavity being disposed between the second section and the protruding body, wherein the cavity is proximal to the upper surface;
the extended area being adjacently positioned to the lower surface;
the extended area being traversed by the plurality of adjustment notches;
the tapered section being disposed towards the lower surface;
the tether being detachably and pivotably coupled to the plurality of adjustment notches;
the tether being secureably anchored opposite the plurality of adjustment notches;
the rounded corner being positioned between the first section and the shank;
the shank being adjacently positioned to the lower surface;
the shank being positioned between the rounded corner and the bend;
the bend being directionally opposed to the rounded corner, wherein the concavity of the bend being opposite the concavity of the rounded corner;
the bend being positioned between the shank and the end section;
the end section being disposed away from the shank; and
the gap being surrounded by the shank, the bend, and the end section.

2. The hook setting trigger as claimed in claim 1 comprises:
the plurality of adjustment notches comprises a low sensitivity notch and a high sensitivity notch;
the low sensitivity notch being diametrically opposed to the high sensitivity notch on the extended area; and
the high sensitivity notch being positioned proximal to the second section.

3. The hook setting trigger in claim 1 wherein the shank being perpendicular to the upper surface and the lower surface.

4. The hook setting trigger in claim 1, wherein the bend being positioned further from the lower surface than the extended area relative to a vertical axis positioned perpendicular to the upper surface and the lower surface.

5. The hook setting trigger in claim 1, wherein the center of mass of being on the first section proximal to the lower surface.

6. A hook setting trigger comprises:
a line catch;
an elongated body;
an eyelet mount;
a tension adjuster;
a tether;
the line catch comprises an rounded corner, a shank, a bend, a gap and an end section;
the elongated body comprises a first section, a second section, an upper section, and a lower section;
the eyelet mount comprises a protruding body and a cavity;
the tension adjuster comprises an extended area and a plurality of adjustment notches;
the extended area comprises a tapered section;
the plurality of adjustment notches comprises a low sensitivity notch and a high sensitivity notch;
the elongated body being positioned between the tension adjuster and the line catch;
the eyelet mount being adjacently positioned to the elongated body;
the eyelet mount being proximal to the tension adjuster;
the first section being positioned between the eyelet mount and the rounded corner;
the second section being positioned between the tension adjuster and the eyelet mount;
the eyelet mount being positioned coincident with the upper surface;
the protruding body projects out of the upper surface biased towards the tension adjuster;
the cavity being disposed between the second section and the protruding body, wherein the cavity is proximal to the upper surface;
the extended area being adjacently positioned to the lower surface;
the extended area being traversed by the plurality of adjustment notches;
the low sensitivity notch being diametrically opposed to the high sensitivity notch on the extended area;
the high sensitivity notch being positioned proximal to the second section;
the tapered section being disposed towards the lower surface;
the tether being detachably and pivotably coupled to the plurality of adjustment notches;
the tether being secureably anchored opposite the plurality of adjustment notches;
the rounded corner being positioned between the first section and the shank;
the shank being adjacently positioned to the lower surface;
the shank being positioned between the rounded corner and the bend;
the shank being perpendicular to the upper surface and the lower surface;
the bend being directionally opposed to the rounded corner, wherein the concavity of the bend being opposite the concavity of the rounded corner;
the bend being positioned between the shank and the end section;
the end section being disposed away from the shank; and
the gap being surrounded by the shank, the bend, and the end section.

7. The hook setting trigger in claim 6, wherein the bend being positioned further from the lower surface than the extended area relative to a vertical axis positioned perpendicular to the upper surface and the lower surface.

8. The hook setting trigger in claim 6, wherein the center of mass of being on the first section proximal to the lower surface.

9. A hook setting trigger comprises:
a line catch;
an elongated body;
an eyelet mount;
a tension adjuster;
a tether;
the line catch comprises an rounded corner, a shank, a bend, a gap and an end section;
the elongated body comprises a first section, a second section, an upper section, a lower section, and a center of mass;
the eyelet mount comprises a protruding body and a cavity;
the tension adjuster comprises an extended area and a plurality of adjustment notches;
the extended area comprises a tapered section;
the plurality of adjustment notches comprises a low sensitivity notch and a high sensitivity notch;
the elongated body being positioned between the tension adjuster and the line catch;
the eyelet mount being adjacently positioned to the elongated body;
the eyelet mount being proximal to the tension adjuster;
the first section being positioned between the eyelet mount and the rounded corner;
the center of mass of being positioned within the first section proximal to the lower surface;
the second section being positioned between the tension adjuster and the eyelet mount;
the eyelet mount being positioned coincident with the upper surface;
the protruding body projects out of the upper surface biased towards the tension adjuster;
the cavity being disposed between the second section and the protruding body, wherein the cavity is proximal to the upper surface;
the extended area being adjacently positioned to the lower surface;
the extended area being traversed by the plurality of adjustment notches;
the low sensitivity notch being diametrically opposed to the high sensitivity notch on the extended area;
the high sensitivity notch being positioned proximal to the second section;
the tapered section being disposed towards the lower surface;
the tether being detachably and pivotably coupled to the plurality of adjustment notches;
the tether being secureably anchored opposite the plurality of adjustment notches;
the rounded corner being positioned between the first section and the shank;
the shank being adjacently positioned to the lower surface;
the shank being positioned between the rounded corner and the bend;
the shank being perpendicular to the upper surface and the lower surface;
the bend being directionally opposed to the rounded corner, wherein the concavity of the bend being opposite the concavity of the rounded corner;
the bend being positioned between the shank and the end section;
the end section being disposed away from the shank; and
the gap being surrounded by the shank, the bend, and the end section.

10. The hook setting trigger in claim 9, wherein the bend being positioned further from the lower surface than the extended area relative to a vertical axis positioned perpendicular to the upper surface and the lower surface.
